(19) United States
(12) Patent Application Publication
(10) Pub. No.: US 2025/0054477 A1
(43) Pub. Date: Feb. 13, 2025

(54) Sound Amplification Block Made of Air-Permeable Material and Air-Absorbing Material and Having Layered Structure, and Manufacturing Method Thereof

(71) Applicant: EM-TECH Co., Ltd., Gyeongsangnam-do (KR)

(72) Inventors: Yong-Hee Oh, Gyeongsangnam-do (KR); Jae-Hwa Lim, Gyeongsangnam-do (KR)

(21) Appl. No.: 18/718,671

(22) PCT Filed: Dec. 16, 2022
(86) PCT No.: PCT/KR2022/020642

§ 371 Date: Jun. 11, 2024

(30) Foreign Application Priority Data
Dec. 16, 2021 (KR) 10-2021-0180616
Dec. 16, 2021 (KR) 10-2021-0180617

(51) Int. Cl. G10K 11/08; G10K 11/168; H04R 31/00

(52) U.S. Cl. CPC G10K 11/08; G10K 11/168; H04R 31/003; H04R 2231/001

(57) ABSTRACT

Provided are a sound amplifying block formed of a permeable material and an air adsorbing material and having a layered structure and a method of manufacturing the same.

The sound amplifying block formed of a permeable material and an air adsorbing material and having a layered structure includes a porous grain formed by a first porous material that is an air adsorbing material that serves to amplify sound, a second porous material that is a permeable material and has a pore size and porosity greater than those of the first porous material, and a binder and a structural gap formed in a process of freezing the porous grain and formed between porous grains.

### TECHNICAL FIELD

The present disclosure relates to a sound amplifying block formed of a permeable material and an air adsorbing material and having a layered structure and a method of manufacturing the same.

### BACKGROUND

Microspeakers, devices that are installed in portable devices and generates sound, and have been installed in various devices with the recent development of mobile devices. In particular, recently developed mobile devices have become lighter, smaller, and slimmer for easier portability, and accordingly, microspeakers installed in mobile devices have also been required to be smaller and slimmer.

However, when microspeakers are miniaturized and slimmed, the area of a diaphragm decreases and the size of a resonance space in which sound generated when the diaphragm vibrates resonates and is amplified also decreases, so there is a problem in that sound pressure is reduced. The reduction in sound pressure is especially noticeable in a low-frequency range, and in order to strengthen sound pressure in the low-frequency range, technology of disposing an air adsorbent, a porous material, in a resonance space so that the porous material adsorbs air molecules to create a virtual acoustic space, improve a sound pressure level (SPL) of a low frequency range, and reduce total harmonic distortion (THD) has been developed.

FIG. 1 is a diagram illustrating a microspeaker enclosure filled with porous granules according to the related art. According to the related art, the microspeaker 1 is mounted in enclosure cases 2 and 3, and a back volume 4 is formed between the upper and lower enclosure cases 2 and 3. The back volume 4 communicates with a back hole of the microspeaker 1, and the back volume 4 is filled with porous granules 5. As the porous particles 5 adsorb air molecules, they form a virtual acoustic space, obtaining an effect as if the back volume 4 is expanded.

However, the microspeaker enclosure filled with porous granules according to the related art has the disadvantage that noise occurs when the microspeaker 1 generates sound or when an impact is applied to the enclosure and the porous granules 5 vibrate.

In addition, when a porous particle block 10 is attached to an enclosure 30 as shown in FIG. 2, a bond 20 penetrates into the porous particle block 10, which has the disadvantage of deteriorating air adsorption performance of the porous particles.

To solve these shortcomings, technologies have been disclosed to block porous granules and install the same in an enclosure. However, even when a block is formed with the same material and ratio as those of conventional porous granules, the corresponding block has very low performance of improving acoustic characteristics. This is because an air circulation rate is very low as the gaps between the porous grains disappear.

To solve this problem, the air circulation rate should be increased by controlling a pore size distribution inside the porous block.

### SUMMARY

Therefore, an aspect of the present disclosure is to provide a sound amplifying block formed of a permeable material and an air adsorbing material and having a layered structure.

According to an aspect of the present disclosure, there is provided a sound amplifying block formed of a permeable material and an air adsorbing material and having a layered structure, including: a porous grain formed by a first porous material that is an air adsorbing material that serves to amplify sound, a second porous material that is a permeable material and has a pore size and porosity greater than those of the first porous material, and a binder; and a structural gap formed in a process of freezing the porous grain and formed between porous grains.

As another aspect of the embodiment, the porous grain may have a wall structure, and the structural gap may be an empty space having a size of 400 nm to 10 um formed between walls.

As another aspect of the embodiment, a particle size of the first porous material may be 200 nm to 5 um, and a particle size of the second porous material may be 1 um to 100 um.

As another aspect of the embodiment, the first porous material may be one or more materials selected from metal-organic frameworks (MOFs), zeolite, activated carbon, and magnesium silicate.

As another aspect of the embodiment, the second porous material may be aerogel.

As another aspect of the embodiment, the second porous material may be included in an amount of 40% or less by weight of the first porous material.

As another aspect of the embodiment, the aerogel may include one or more of silica aerogel, carbon aerogel, alumina aerogel, and titania aerogel.

As another aspect of the embodiment, the aerogel may have a porosity of 80% or greater.

As another aspect of the embodiment, the second porous material may be a material selected from high-porosity materials having a porosity of 50% or greater, including silica, MOFs, and a high-porosity porous metal.

As another aspect of the embodiment, the binder may be one of inorganic binders including sodium silicate, silica sol, and phosphate binders, organic binders including epoxy, polystyrene, polyvinyl alcohol, ethyl silicate, and SBR, and composite binders as a mixture of inorganic binders and organic binders.

As another aspect of the embodiment, an adhesive or coating may be applied to a surface of the sound amplifying block or added during manufacturing to improve mechanical strength.

As another aspect of the embodiment, a growth direction and the structural gap of the porous grains may be arranged in a direction perpendicular to an attachment surface of the sound amplifying block.

As another aspect of the embodiment, a ratio of a pore volume [cm³/g] of 6-nm pores to a pore volume [cm³/g] of 3-nm pores possessed by the sound amplifying block may satisfy

$$\frac{6 nm Pore Volume [ {cm}^{3} / g ]}{3 nm Pore Volume [ {cm}^{3} / g ]} \geq 0.6 ( BJH Distortion Cumulative Pore Volume ) .$$

According to an aspect of the present disclosure, there is provided a method of manufacturing a sound amplifying block having a layered structure, including: a first operation of preparing a slurry by mixing a first porous material, which is an air adsorbing material that serves to amplify sound, a second porous material, which is a permeable material and has a larger pore size and porosity than those of the first porous material, a binder, a solvent, and an additive; a second operation of injecting the slurry into a mold, bringing the mold containing the slurry into contact with a freezing plate maintained at a temperature below a freezing point of the slurry, growing grains in a direction of a temperature gradient, and freeze-casting the grains to form a layered structure, and a third operation of sublimating water, while freeze-drying the freeze-cast block, to form a structural gap.

As another aspect of the embodiment, in the first operation, the second porous material may be mixed in an amount of 12 to 72 wt % of the first porous material, the binder may be mixed in an amount of 0 to 10 wt % of the first porous material, the solvent may be mixed in an amount of 80 to 150 wt % of the first porous material, and the additive may be mixed in an amount of 0 to 10 wt % of the first porous material.

As another aspect of the embodiment, in the third operation, the freezing plate may be maintained at −26° C. to 0° C., and one surface of the mold may be in contact with the freezing plate.

As another aspect of the embodiment, in the second operation, the mold may be installed so that a largest surface of the mold is perpendicular to the freezing plate.

As another aspect of the embodiment, in the second operation, the freeze-casting of the slurry may be completed within 40 minutes.

As another aspect of the embodiment, in the third operation, freeze-drying may be performed within 36 hours in a vacuum state of 1 Torr or less.

As another aspect of the embodiment, in the second operation, freeze-casting may be performed using the enclosure case of the microspeaker, as a mold.

As another aspect of the embodiment, the first porous material may be one or more materials selected from MOFs, zeolite, activated carbon, and magnesium silicate.

As another aspect of the embodiment, the second porous material may have a porosity of 50% or greater and a density of 1.2 kg/m³ or less.

As another aspect of the embodiment, the second porous material may be one or more materials selected from aerogel, mesoporous silica, and a mesoporous carbon structure.

As another aspect of the embodiment, the solvent may be one or more alcohols selected from water, methanol, ethanol, propanol, isopropyl alcohol, butanol, pentanol, hexanol, heptanol, and octanol.

As another aspect of the embodiment, the binder may be one of inorganic binders including sodium silicate, silica sol, and phosphate binders, organic binders including epoxy, polystyrene, polyvinyl alcohol, ethyl silicate, and SBR, and composite binders as a mixture of inorganic binders and organic binders.

In the sound amplifying block provided by an embodiment, when a first porous material that absorbs air to serve as a virtual back volume and enhances low-frequency range performance is blocked and provided in an enclosure microspeaker, the first porous material is mixed with a second porous material and freeze-cast, so that the porous material may be easily installed, while the ability to improve the acoustic characteristics of the microspeaker is maintained.

### BRIEF DESCRIPTION OF THE DRAWINGS

FIG. 1 is a diagram illustrating a microspeaker enclosure filled with a porous material according to the related art;

FIG. 2 is a view illustrating a block formed of a porous material according to the related art attached to a microspeaker enclosure;

FIG. 3 is a 300× scanning microscope photograph of a sound amplifying block formed of a permeable material and an air adsorbing material and having a layered structure according to an embodiment;

FIG. 4 is a 300× scanning microscope photograph of a sound amplifying block formed of a permeable material and an air adsorbing material and having a layered structure according to an embodiment; and

FIG. 5 is a graph showing comparison of sound pressure over frequency among an enclosure microspeaker to which an air adsorbing material according to the related art is not applied, an enclosure microspeaker to which a sound amplifying block according to the related art is installed, and a sound amplifying block formed of a permeable material and an air adsorbing material and having a layered structure according to an embodiment.

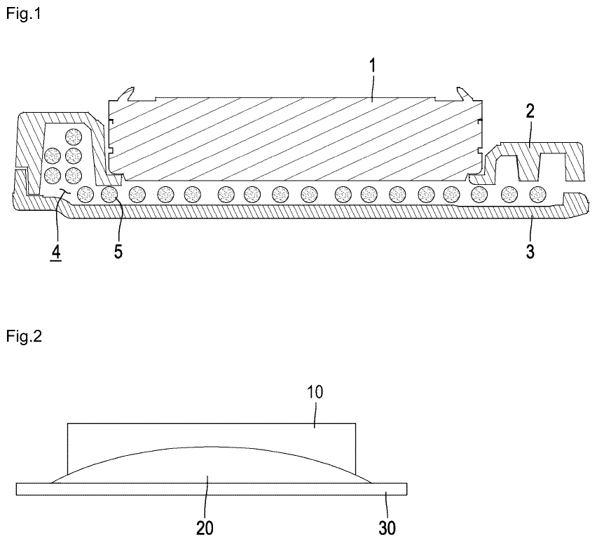

### DETAILED DESCRIPTION

Hereinafter, the present disclosure is described in detail with reference to the accompanying drawings.

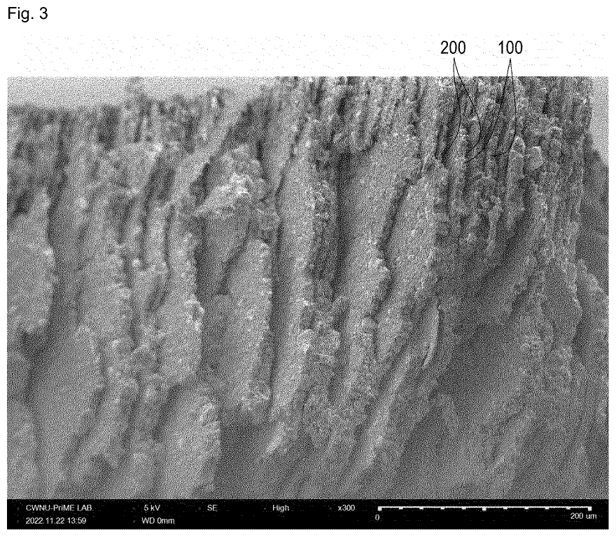

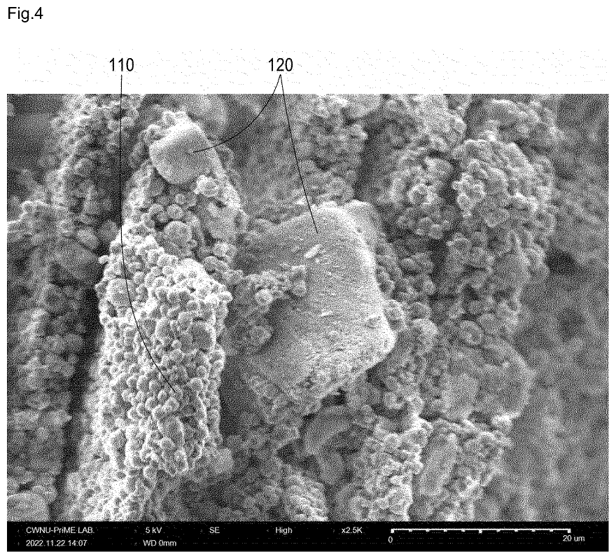

FIG. 3 is a 300× scanning microscope photograph of a sound amplifying block formed of a permeable material and an air adsorbing material and having a layered structure according to an embodiment, and FIG. 4 is a 300× scanning microscope photograph of a sound amplifying block formed of a permeable material and an air adsorbing material and having a layered structure according to an embodiment.

The embodiment provides manufacturing a sound amplifying block formed from a sound amplifier capable of amplifying sound by adsorbing air and having a size of 1 mm or more and capable of maximizing air adsorption performance.

The sound amplifying block according to an embodiment includes porous grains grown by freeze-casting and freeze-drying a first porous material serving to amplifying sound with an air adsorbing material, a second porous material, as a permeable material, having a pore size and porosity greater than those of the first porous material, and a binder and a structural gap 200 formed during a freezing process of the porous grains 100 and formed between porous grains.

The porous grains 100 is a mixture of a first porous material 110 and a second porous materials 120. The first porous material 110 is a material having good air adsorption performance and having a particle size of 200 nm to 5 um, and the second porous material 120 is a material having good permeability and having a particle size of 1 um to 100 um. The second porous material 120 mixed with the first porous material 110 allows air to pass therethrough so that air may pass through the first porous material 110 included in the sound amplifying block. Meanwhile, in some areas of the porous grains 100, particles of the first porous material 110 are clustered together, and pores naturally occurring between the particles of the first porous material also help airing.

The porous grains 100 have a wall structure, and the structural gap 200 is an empty space having a size of 400 nm to 10 um formed between the walls. The empty space may increase a surface area of the sound amplifying block and improve air adsorption performance, thereby increasing sound amplification performance.

The first porous material 110 may be one or more materials selected from metal-organic frameworks (MOFs), zeolite, activated carbon, and magnesium silicate, and the second porous material 120 may be most preferably aerogel, but may be a material selected from high-porosity materials having a porosity of 50% or more, such as silica, MOFs, or a high-porosity porous metal. The aerogel may include any one or more of silica aerogel, carbon aerogel, alumina aerogel, and titania aerogel. At this time, it is preferable that the aerogel has a porosity of 80% or more.

Meanwhile, the second porous material 120 is preferably contained in an amount of 40% or less of a weight of the first porous material 110.

A binder that binds the first porous material 110 and the second porous material 120 may include inorganic binders, such as sodium silicate, silica sol, and phosphate binders, organic binders, such as epoxy, polystyrene, polyvinyl alcohol, ethyl silicate, and SBR, and a composite binder that is a mixture of an inorganic binder and an organic binder. At this time, in order to improve mechanical strength of the sound amplifying block, an adhesive or coating agent may be applied to the surface or added during a manufacturing process.

Meanwhile, the sound amplifying block, which is formed of a permeable material and an air adsorbing material and has a layered structure, is attached to or installed in the enclosure case of the microspeaker and serves to amplify sound of the microspeaker. In this case, it is preferable that a growth direction of the grains 100 of the sound amplifying block, an arrangement direction of the structural gap 200, and an attachment surface of the sound amplifying block are perpendicular to each other.

Meanwhile, the sound amplifying block formed of a permeable material and an air adsorbing material and having a layered structure may be manufactured by the following method.

The sound amplifying block is manufactured through a first operation of preparing a slurry by mixing the first porous material 110, which is an air adsorbing material that serves to amplify sound, the second porous material 120, which is a permeable material and has a larger pore size and porosity than those of the first porous material, a binder, a solvent, and an additive, a second operation of injecting the slurry into a mold, bringing the mold containing the slurry into contact with a freezing plate maintained at a temperature below a freezing point of the slurry, growing grains in a direction of a temperature gradient, and freeze-casting the grains to form a layered structure, and a third operation of sublimating the solvent, while freeze-drying the freeze-cast block, to form a structural gap.

In the first operation, the second porous material 120 is mixed in the amount of 12 to 72 wt % of the first porous material 110, the binder is mixed in the amount of 0 to 10 wt % of the first porous material 110, the solvent is mixed in the amount of 80 to 150 wt % of the first porous material 110, and the additive is mixed in the amount of 0 to 10 wt % of the first porous material 110.

In the third operation, the freezing plate is maintained at −26° C. to 0° C., and one side of the mold into which the slurry is injected is in contact with the freezing plate. Preferably, the mold is installed so that the largest surface of the mold is perpendicular to the freezing plate. When the mold is disposed in this manner and the grains are grown through freeze-casting, the layered structure of the grains is perpendicular to the largest surface of the sound amplifying block manufactured in the mold. Therefore, the largest surface of the sound amplifying block may be used as an attachment surface to be attached to the enclosure case. Here, instead of a mold, the enclosure case of the microspeaker may be used as a mold to perform freeze-casting, thereby integrating the sound amplifying block with the enclosure case.

At this time, in the second operation, the freeze-casting of the slurry is preferably completed within 40 minutes. That is, it is desirable to adjust the temperature of the freezing plate and the thickness and size of the sound amplifying block so that the time taken for the slurry to be completely frozen is less than 40 minutes.

Meanwhile, in the third operation, it is preferable that freeze-drying is performed within 36 hours in a vacuum state of 1 Torr or less.

At this time, the first porous material is preferably one or more materials selected from MOFs, zeolite, activated carbon, and magnesium silicate, and the second porous material preferably has a porosity of 50% or more and a density of 1.2 kg/m3 or less. The second porous material may be one or more materials selected from aerogel, mesoporous silica, and a mesoporous carbon structure.

The solvent mixed to prepare the slurry in the first operation is preferably at least one of alcohols selected from the group consisting of water, methanol, ethanol, propanol, isopropyl alcohol, butanol, pentanol, hexanol, heptanol, and octanol.

The binder mixed to prepare the slurry in the first operation is preferably at least one of an inorganic binder, such as sodium silicate, silica sol, and a phosphate binder, an organic binder, such as epoxy, polystyrene, polyvinyl alcohol, ethyl silicate, and SBR, and a composite binder as a mixture of an inorganic binder and an organic binder.

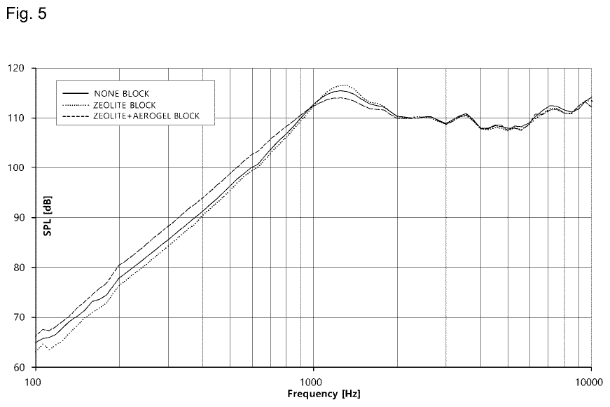

FIG. 5 is a graph showing comparison of sound pressure over frequency among an enclosure microspeaker to which an air adsorbing material according to the related art is not applied, an enclosure microspeaker to which a sound amplifying block according to the related art is installed, and a sound amplifying block formed of a permeable material and an air adsorbing material and having a layered structure according to an embodiment.

Referring to FIG. 5, it can be seen that, when the sound amplifying block is manufactured only with zeolite, an air adsorbing material, without a structure to increase permeability, the sound performance in the low-frequency range is rather poor compared to a case in which the sound amplifying block is not installed in the enclosure case. In contrast, it can be seen that the sound amplifying block formed of a permeable material and an air adsorbing material and having a layered structure according to the embodiment has improved sound performance in the low-frequency range, compared to the case in which the sound amplifying block is not installed in the enclosure case.

1. A sound amplifying block formed of a permeable material and an air adsorbing material and having a layered structure, the sound amplifying block comprising:
a porous grain formed by a first porous material that is an air adsorbing material that serves to amplify sound, a second porous material that is a permeable material and has a pore size and porosity greater than those of the first porous material, and a binder; and
a structural gap formed in a process of freezing the porous grain and formed between porous grains.

2. The sound amplifying block of claim 1, wherein the porous grain has a wall structure, and the structural gap is an empty space having a size of 400 nm to 10 um formed between walls.

3. The sound amplifying block of claim 1, wherein a particle size of the first porous material is 200 nm to 5 um, and a particle size of the second porous material is 1 um to 100 um.

4. The sound amplifying block of claim 1, wherein the first porous material is one or more materials selected from metal-organic frameworks (MOFs), zeolite, activated carbon, and magnesium silicate.

5. The sound amplifying block of claim 1, wherein the second porous material is aerogel.

6. The sound amplifying block of claim 5, wherein the second porous material is included in an amount of 40% or less by weight of the first porous material.

7. The sound amplifying block of claim 5, wherein the aerogel includes one or more of silica aerogel, carbon aerogel, alumina aerogel, and titania aerogel.

8. The sound amplifying block of claim 5, wherein the aerogel has a porosity of 80% or greater.

9. The sound amplifying block of claim 1, wherein the second porous material is a material selected from high-porosity materials having a porosity of 50% or greater, including silica, MOFs, and a high-porosity porous metal.

10. The sound amplifying block of claim 1, wherein the binder is one of inorganic binders including sodium silicate, silica sol, and phosphate binders, organic binders including epoxy, polystyrene, polyvinyl alcohol, ethyl silicate, and SBR, and composite binders as a mixture of inorganic binders and organic binders.

11. The sound amplifying block of claim 1, wherein an adhesive or coating is applied to a surface of the sound amplifying block or added during manufacturing to improve mechanical strength.

12. The sound amplifying block of claim 1, wherein a growth direction and the structural gap of the porous grains are arranged in a direction perpendicular to an attachment surface of the sound amplifying block.

13. The sound amplifying block of claim 1, wherein a ratio of a pore volume [cm³/g] of 6-nm pores to a pore volume [cm³/g] of 3-nm pores possessed by the sound amplifying block satisfies
$$\frac{6 nm Pore Volume [ {cm}^{3} / g ]}{3 nm Pore Volume [ {cm}^{3} / g ]} \geq 0.6 ( BJH Distortion Cumulative Pore Volume ) .$$

14. A method of manufacturing a sound amplifying block having a layered structure, the method comprising:
a first operation of preparing a slurry by mixing a first porous material, which is an air adsorbing material that serves to amplify sound, a second porous material, which is a permeable material and has a larger pore size and porosity than those of the first porous material, a binder, a solvent, and an additive;
a second operation of injecting the slurry into a mold, bringing the mold containing the slurry into contact with a freezing plate maintained at a temperature below a freezing point of the slurry, growing grains in a direction of a temperature gradient, and freeze-casting the grains to form a layered structure, and
a third operation of sublimating water, while freeze-drying the freeze-cast block, to form a structural gap.

15. The method of claim 14, wherein, in the first operation, the second porous material is mixed in an amount of 12 to 72 wt % of the first porous material, the binder is mixed in an amount of 0 to 10 wt % of the first porous material, the solvent is mixed in an amount of 80 to 150 wt % of the first porous material, and the additive is mixed in an amount of 0 to 10 wt % of the first porous material.

16. The method of claim 14, wherein, in the third operation, the freezing plate is maintained at −26° C. to 0° C., and one surface of the mold is in contact with the freezing plate.

17. The method of claim 14, wherein, in the second operation, the mold is installed so that a largest surface of the mold is perpendicular to the freezing plate.

18. The method of claim 14, wherein, in the second operation, the freeze-casting of the slurry is completed within 40 minutes.

19. The method of claim 14, wherein, in the third operation, freeze-drying is performed within 36 hours in a vacuum state of 1 Torr or less.

20. The method of claim 14, wherein, in the second operation, freeze-casting is performed using the enclosure case of the microspeaker, as a mold.

21. The method of claim 14, wherein the first porous material is one or more materials selected from MOFs, zeolite, activated carbon, and magnesium silicate.

22. The method of claim 14, wherein the second porous material has a porosity of 50% or greater and a density of 1.2 kg/m³ or less.

23. The method of claim 14, wherein the second porous material is one or more materials selected from aerogel, mesoporous silica, and a mesoporous carbon structure.

24. The method of claim 14, wherein the solvent is one or more alcohols selected from water, methanol, ethanol, propanol, isopropyl alcohol, butanol, pentanol, hexanol, heptanol, and octanol.

25. The method of claim 14, wherein the binder is one of inorganic binders including sodium silicate, silica sol, and phosphate binders, organic binders including epoxy, polystyrene, polyvinyl alcohol, ethyl silicate, and SBR, and composite binders as a mixture of inorganic binders and organic binders.
